(19) United States
(12) Patent Application Publication
(10) Pub. No.: US 2010/0181388 A1
(43) Pub. Date: Jul. 22, 2010

(54) CONNECTION STATION FOR A SOAKER HOSE AND/OR DRIP LINE LAWN IRRIGATION SYSTEM

(76) Inventor: Jim Harrington, Alpharetta, GA (US)

Correspondence Address: SMITH, GAMBRELL & RUSSELL, SUITE 3100, PROMENADE II, 1230 PEACHTREE STREET, N.E., ATLANTA, GA, 30309-3592, US

(21) Appl. No.: 12/355,289

(22) Filed: Jan. 16, 2009

(51) Int. Cl. B05B 15/06

(52) U.S. Cl. 239/200

(57) ABSTRACT

A connection station or unit for use with an in-ground water station housing and a drip irrigation system, a soaker hose system, or the like, the station having a cap, a threaded pipe segment, a connector, and a filter and pressure reducer unit. The connector can be a nipple connector suitable for use with a drip irrigation system, a threaded connector suitable for use with a soaker hose connector, or any other type of connector suitable for connecting the invention to an irrigation system. The station can be used as an original installation or as a retrofit for currently installed in-ground irrigation systems.

### BACKGROUND OF THE INVENTION

1. Technical Field

This invention relates generally to devices for irrigating trees, shrubs, lawns, and other landscape features, and more specifically to stations on in-ground irrigation systems for allowing soaker hoses, drip lines, and the like to be coupled to the irrigation systems. The invention further relates to retrofit components for use with in-ground irrigation system sprinkler station housings to convert the stations for use in connection with soaker hoses, drip lines, and the like.

2. Prior Art

In-ground lawn and garden irrigation systems are relatively common throughout the world for providing water to landscape features. Typical in-ground irrigation systems comprise a water source, underground piping to bring the water to various locations or stations about the lawn or garden, and sprinkler heads to direct the water onto the lawn or garden. The stations often are underground housings containing the sprinklers, and the sprinklers often are of the pressure-rising variety, rising and allowing the water to be emitted when the water pressure within the piping and housings rises to a certain activation level. Various known irrigation systems, and particularly sprinklers and housings, of this type are manufactured and/or distributed by Rain Bird Consumer Products Manufacturing Corporation, Hunter Industries, Inc., and The Toro Company, and are represented by U.S. Pat. Nos. 4,479,611, 4,253,608, and 3,854,664, as well as many others.

Many in-ground irrigation systems are not efficient in that they may direct water onto the street or other unintended locations, they may direct too much or too little water onto various portions of the lawn or garden, and they may allow water to evaporate during spraying without ever contacting the lawn or garden. Drip lines or drip irrigation utilizes a network of pipes and/or hoses to allow water to drip slowly onto the vegetation, either onto the surface of the soil itself or directly onto plant roots. Drip irrigation minimizes the use of water and generally is considered more efficient than sprinkler systems. U.S. Pat. No. 4,473,191 illustrates a typical drip irrigation system. Soaker hoses are a type of drip irrigation and are hoses having a multitude of small perforations along the length of the hose. The soaker hoses are laid on the lawn or garden, and the water emanates from the soaker hoses directly onto the ground. U.S. Pat. No. 4,168,799 illustrates a typical soaker hose.

With the increasing value put on water, many people are searching for new ways of irrigating lawns and gardens as efficiently as possible. However, as many people have in-ground irrigation systems already installed, the time, cost, and mess possibly associated with removing the in-ground irrigation system and replacing it with a drip lines or soaker hoses is not attractive. Likewise, the cost and time needed for researching and developing new drip lines or soaker hose systems may not be attractive either. Therefore, there is a need for new drip lines and soaker hose systems that are efficient in the use of water, relatively lower in cost to manufacture and install, are not time-consuming in installation, and/or create a smaller mess during installation. It is to these needs and others that the present invention is directed.

### BRIEF SUMMARY OF THE INVENTION

Briefly, the present invention is a combination of elements that can be coupled to a typical in-ground irrigation system thereby allowing the system to function as a drip irrigation system or to accommodate drip lines and/or soaker hoses. The invention can be a retrofit into an existing in-ground sprinkler irrigation system or can be part of a newly installed irrigation system. Preferred embodiments of the invention utilize the existing or standard piping and housing stations of an in-ground irrigation system and uses the combination of elements instead of the sprinkler heads to allow for the connection of a drip lines or soaker hoses to the housing stations. The various secondary elements of the typical irrigation system, such as valves, connectors, switches, pumps, and the like also can be used in connection with the present invention.

The base irrigation system comprises the underground piping for directing water to at least one watering station, a water source, and various secondary components for effecting the proper operation of such a system. All of these components are known in the art. Various types of housings for the watering station are suitable for use with the present invention, including those shown in FIGS. 1-3 herein. These housings generally are hollow cylindrical or cup like structures having a water inlet port or connection and an open top. A removable cap (usually by screw threads) fits onto the open top to close the housing. When installed, the housing is below ground level with the cap generally at approximately the ground level. In current sprinkler systems, a rising sprinkler head cooperates with the cap such that when the water pressure in the housing is below a certain level, the sprinkler head remains in the down position within the housing and when the water pressure in the housing is above the certain level, the sprinkler head rises into the up position and extends out of the housing and above the ground level in a known manner. Typically, a plurality of housings are attached to the piping in series or in parallel.

In the present invention, the inventive combination of components substitutes for the sprinkler head. Illustrative embodiments of the inventive combination of components comprise a threaded pipe section extending through the cap and a connector for connecting the drip irrigation system or the soaker hose. A rubber grommet can be used to seal the threaded pipe section to the cap to prevent water from exiting the housing except through the threaded pipe section. Preferably, the cap and the rubber grommet supplied with the housing is used. Alternatively, a one-piece cap comprising a connector can be used. A filter and/or pressure reducer can be coupled to the threaded pipe section to prevent debris from entering the drip line or the soaker hose and to reduce the pressure of the water entering the drip line or soaker hose to a pressure level that will nor damage the drip line or soaker hose. Various secondary components such as caps, O-rings, and the like also can be included to complete the device and system.

A drip line, a soaker hose, or any of a variety of other irrigation systems can be coupled to the housing, and therefore to the water source, via the connector attached to the threaded pipe section. When the water source is allowed to flow through the piping to the housing, the water passes through the housing and out through the threaded pipe section and the connector into the drip lines or soaker hoses. The use of pressure reducers in one or more of the housings helps to prevent high pressure damage to the drip lines or soaker hoses, and helps to ensure that water travels throughout the piping system to other housings and other drip lines or soaker hoses. Thus, the in-ground irrigation system functions as a drip irrigation system or a soaker hose irrigation system.

Other features, aspects, and advantages of the invention will become apparent from the following detailed description of the preferred embodiments, taken in conjunction with the accompanying drawings. In the prior art views of FIGS. 1-3, the reference numerals in each figure relate only to that specific figure. In the present invention views of FIGS. 4-8, like reference numerals represent like components throughout FIGS. 4-8, illustrating by way of example the principles of the invention.

### BRIEF DESCRIPTION OF THE DRAWINGS

FIG. 1 is a cross section of a first prior art in-ground sprinkler housing suitable for use with the present invention.

FIG. 2 is a cross section of a second prior art in-ground sprinkler housing suitable for use with the present invention.

FIG. 3 is a cross section of a third prior art in-ground sprinkler housing suitable for use with the present invention.

FIG. 4 is an exploded side view of the embodiment of the present invention.

FIG. 5 is an exploded sectional side view of an embodiment of the present invention.

FIG. 6 is a side sectional view of an embodiment of the present invention.

FIG. 7. is a perspective view of a connector suitable for use with a drip line requiring a nipple friction connection.

FIG. 8 is a perspective view of a connector suitable for use with a soaker hose requiring a threaded connection.

### DETAILED DESCRIPTION OF PREFERRED EMBODIMENTS

Reference will now be made in detail to preferred embodiments of the invention, examples of which are illustrated in the accompanying drawings. While the invention will be described in conjunction with the preferred embodiments, it will be understood that they are not intended to limit the invention to those embodiments. On the contrary, the invention is intended to cover alternatives, modifications and equivalents, which may be included within the spirit and scope of the invention as defined by the appended claims. For example, while the invention is disclosed primarily in conjunction with drip lines and soaker hoses, this is for illustrative purpose only.

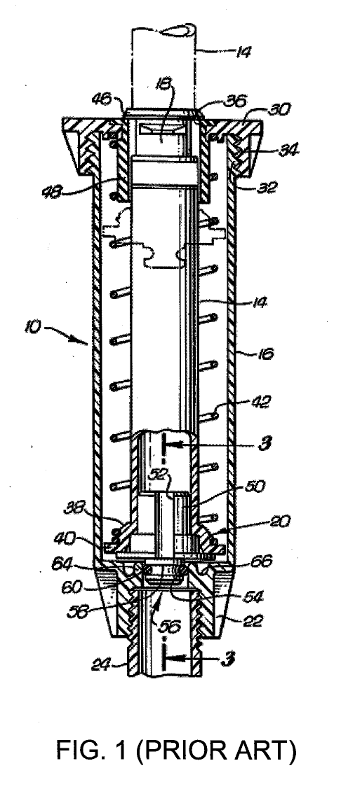

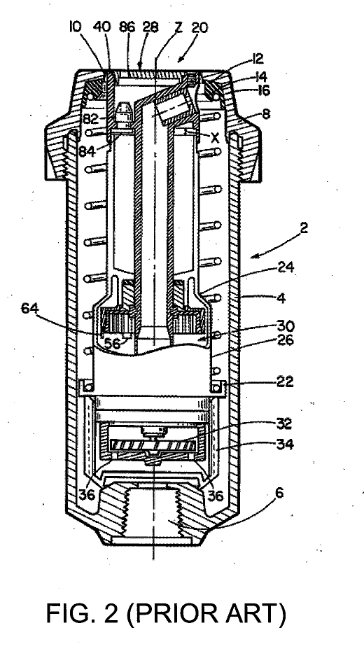

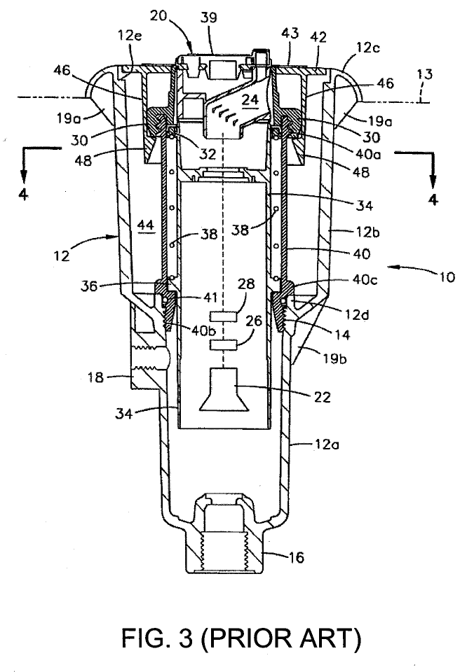

FIG. 1 is a cross section of a first prior art in-ground sprinkler housing suitable for use with the present invention. FIG. 2 is a cross section of a second prior art in-ground sprinkler housing suitable for use with the present invention. FIG. 3 is a cross section of a third prior art in-ground sprinkler housing suitable for use with the present invention. These representative housing are shown merely to illustrate that the present invention can be used with, or retrofitted to, the various in-ground irrigation systems currently available, as well as to new systems.

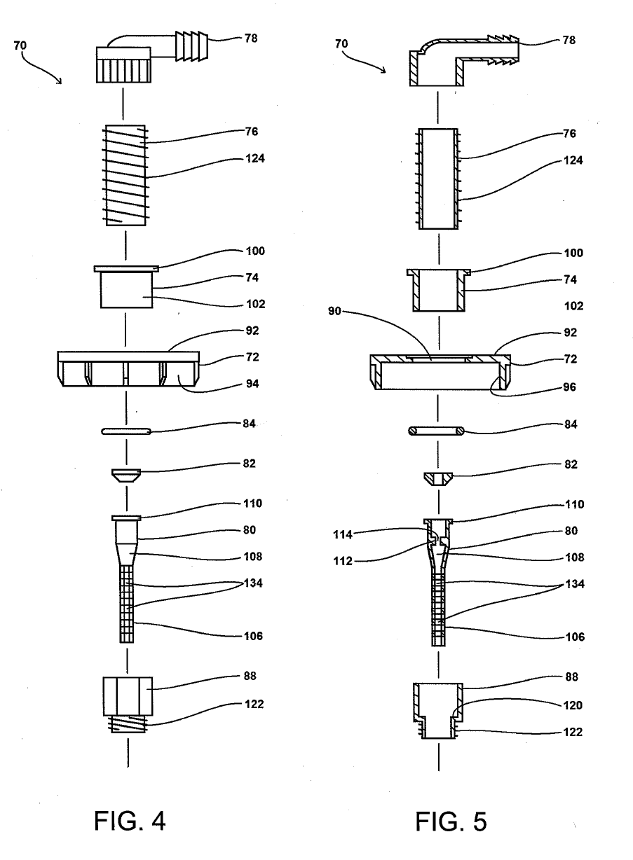

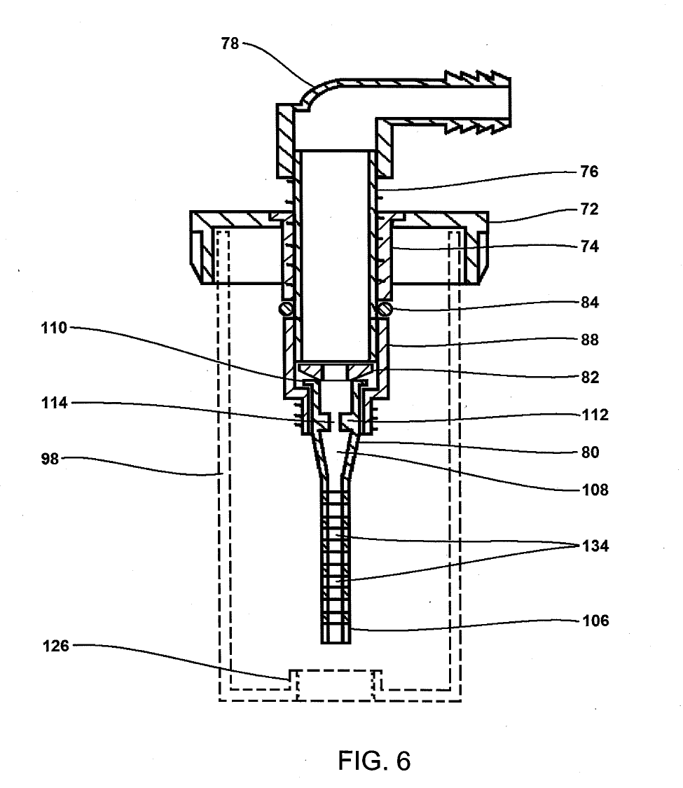

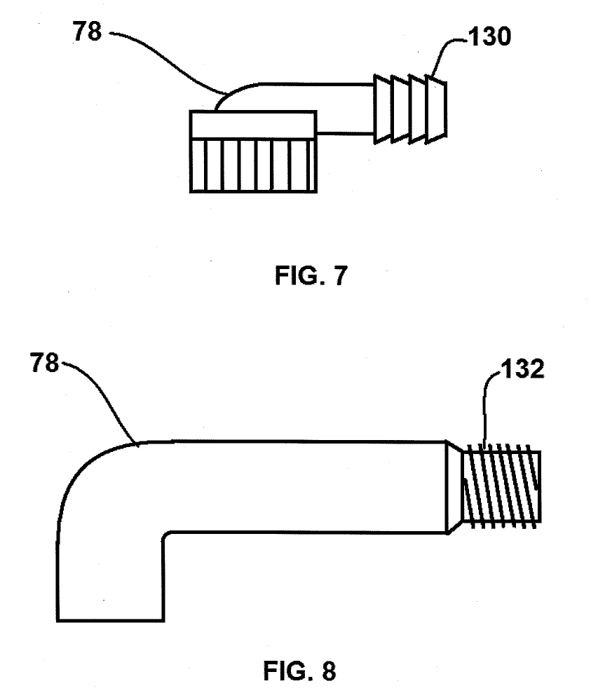

FIG. 4 is an exploded side view of the embodiment of the present invention. FIG. 5 is an exploded sectional side view of an embodiment of the present invention similar to that of FIG. 4. FIG. 6 is a side sectional view of the constructed invention with a generic housing shown in ghost lines. FIG. 7. is a perspective view of a connector suitable for use with a typical drip line and comprises a nipple connector. FIG. 8 is a perspective view of a connector suitable for use with a typical soaker hose and comprises a screw thread connector.

Referring to FIGS. 1-3, several prior art water stations are shown as illustrative examples of housing with which the present invention can be used. As illustrated in the exemplary drawings of the prior art and the present invention, a water station housing (reference numeral 16 in FIG. 1, reference numeral 4 in FIG. 2, reference numeral 12 in FIG. 3, and reference numeral 98 in FIGS. 4-8) is connected to a water supply pipe, which may be installed underground, for receiving a flow of water under pressure from a suitable water supply. A rising sprinkler head (reference numeral 18 in FIG. 1, reference numeral 20 in FIG. 2, and reference numeral 20 in FIG. 3) is contained within housing in FIGS. 1-3, while the present invention 70 is contained within housing 98 in FIGS. 4-8.

Referring now to FIG. 1, a prior art sprinkler housing manufactured by Rain Bird Consumer Products Manufacturing Corporation under the 1800 series is shown. The rising sprinkler 10 includes the sprinkler housing 16 having a generally upright cylindrical shape with an inlet fitting 22 at its bottom end, which can be internally threaded as illustrated, for appropriate connection to a relatively short riser pipe 24 coupled in turn via a T-shaped fitting 26 to the water supply line 12. The sprinkler housing is constructed typically by a high production molding or casting process preferably from a relatively lightweight molded plastic or the like suitable for underground installation with its upper end disposed substantially flush with the surface of the soil 28, although other materials, such as metal castings, can be used. The upper end of the housing 16 supports an annular cap 30 shown secured to the housing by interengaging sets of threads 32 and 34 and defining a central opening 36 through which the pop-up stem 14 is movable between the retracted position and the elevated spraying position. The housing 16 is suitable for use with the present invention.

Referring now to FIG. 2, a prior art sprinkler housing manufactured by The Toro Company under the Super 600 series is shown. The sprinkler head is generally illustrated as 2. Sprinkler head 2 includes a riser 20 that rises from a lower retracted position in which it is contained inside the housing to an upper raised position in which it is raised out of the housing for conducting a sprinkling operation. Sprinkler head 2 includes a cylindrical body 4 having a water inlet 6 at the lower end thereof. Inlet 6 has interior screw threads for coupling it to a conventional fitting on a water supply pipe or line. The upper end of housing 4 is dosed by a screw threaded cap 8. Cap 8 has a central circular opening 10 through which riser 20 extends. A seal 12 is press fit or otherwise secured into the top of cap 8 beneath the top surface thereof. Seal 12 includes an annular groove that receives the top end of a spring 16 whose lower end is received on an annular flange 22 on riser 20. Spring 16 forces riser 20 down to its lower retracted position. In addition, seal member 12, which may be of a resilient material such as rubber, has a slanted sealing surface 14 that engages with a similarly shaped surface 24 on the outside of riser 20 for sealing the riser 20 to the outer body 4 in its upper or raised position. This prevents water from leaking out between riser 20 and cap 8 when the sprinkler has the riser in its up and operating position. The cylindrical body 4 is the equivalent of a housing and is suitable for use with the present invention.

Referring now to FIG. 3, a prior art sprinkler housing manufactured by Hunter Industries, Inc. is shown. A sprinkler unit 10 includes an upwardly opening, generally cylindrical mounting case 12. The mounting case 12 is adapted to be buried in a subterranean location in a substantially vertical orientation. The case 12 has a lower smaller diameter section 12a forming a pressure vessel and an upper larger diameter section 12b forming a sprinkler housing. The upper section 12b has a curved upper lip 12c whose terminal lower edge is normally positioned at the level of the grade 13, represented by the top of the soil having the turf to be watered. The case 12 has a female threaded segment 14 at a junction of the lower section 12a and the upper section 12b. The sprinkler 20 is located within the housing formed by the upper section 12b of the case 12 when the sprinkler 20 is retracted. The lower section 12a of the cylindrical mounting case 12 is formed with a female threaded inlet 16 that extends vertically through the bottom wall of the case 12 and permits a male threaded pipe segment of standard diameter from a supply line to be screwed into the same. Inlet 16 is connected to a water supply line for supplying water to the unit. The cylindrical mounting case 12 is preferably injection molded of a suitable plastic as a single unitary structure. The mounting case 12 is the equivalent of a housing and is suitable for use with the present invention.

Referring to FIGS. 4-8, the presenting invention will be disclosed in detail.

Referring now to FIGS. 4 and 5, an exploded side view and an exploded sectional side view, respectively, of an illustrative embodiment of the present invention 70 is shown. The invention 70 is a connection unit between an in-ground water station housing and a drip irrigation system, a soaker hose system, or the like. This illustrative embodiment of the invention 70 comprises threaded pipe segment 76, connector 78, filter and pressure reducer unit 80, washer 82, O-ring 84, and nut 88. Connector 78 is shown as a nipple connector suitable for use with a drip irrigation system, but can also be a soaker hose connector 78 such as that shown in FIG. 8, or any other type of connector suitable for connecting the invention to an irrigation system. Cap 72 and grommet 74 typically are supplied with the original sprinkler housing and preferably are used with the present invention. However, a separate or new cap 72 and grommet 74 can be manufactured and supplied as part of the invention 70.

Threaded pipe segment 76 in inserted through grommet 74 and grommet 74 is inserted through the hole 90 in cap 72 to form a generally water tight unit comprising these three components. A suitable length of threaded pipe segment 76 extends upwards (that is, outward relative to the inside of housing 98) from cap 72 to allow the attachment of connector 78. Likewise, a suitable length of threaded pipe segment 76 extends downward (that is, inward relative to the inside of housing 98) from cap 72 to allow the attachment of the filter and pressure reducer unit 80.

Cap 72 comprises an upper wall 92, a cylindrical side wall 94, and a screw thread 96 on the interior surface of side wall 94. Screw thread 96 cooperates with a screw thread on housing 98 so that cap 72 can be removably secured onto housing 98 in a generally watertight manner. Hole 90 extending through upper wall 92 accommodates grommet 74 and threaded pipe segment 76 as disclosed above, and the shape and size of hole 90 can be selected based on the shape and size of grommet 74 and threaded pipe segment 76. Cap 72 can be manufactured out of any suitable material, including plastics, metals, alloys, ceramics, and composites.

Grommet 74 comprises an upper flange 100 and a cylindrical side wall 102. The interior diameter of side wall 102 can be chosen to cooperate with threaded pipe segment 76 such that threaded pipe segment 76 can be inserted through grommet 74 and held by grommet 74 in a water tight manner. Grommet 74 can be manufactured out of any suitable material, including natural and artificial rubbers and silicones.

Threaded pipe segment 76 can be a structure referred to in the industry as a nipple, and, for example, can be a hollow pipe having an inner diameter of approximately ½ inch (1.27 cm), an outer diameter (to the outside edge of threads) of approximately ¾ inch (1.90 cm), and a length of approximately 2 inches (5.08 cm). Other diameters and lengths are suitable depending on the size of cap 72 and housing 98, and general ranges are an inner diameter of approximately ¼ inch-1 inch (0.64 cm-2.54 cm), an outer diameter of approximately ½ inch-1¼ inch (1.27 cm-3.18 cm), and a length of approximately 1¼ inch-3 inches (3.18 cm-7.62 cm), as this range will fit within most prior art housings. Threaded pipe segment 76 can be manufactured out of any suitable material, including plastics, metals, alloys, ceramics, and composites.

As a first alternative, the cap 72 and threaded pipe segment 76 can be molded as a single component. As a single component, there would be no need for the grommet 74. This cap component could have threaded pipe connections extending upwards away from the housing 98 and downwards into the housing 98 to which the connector 78 and the filter 80/washer 82/O-ring 84/nut 88 combination, respectively, could be attached. As a second alternative, the connector 78 can be part of this single molded component, and then this component would have a threaded pipe connection extending downwards into the housing 98 to which the filter and pressure reducer unit 80/washer 82/O-ring 84/nut 88 combination could be attached. For this second alternative, different single molded components could be made for different applications, such as a drip line component having the connector 78 shown in FIG. 7 and a soaker hose component having the connector 78 shown in FIG. 8.

Filter and pressure reducer unit 80 is inserted through nut 88, O-ring 84 is place over the lower extension of threaded pipe segment 76, and nut 88 is screwed onto the lower extension of threaded pipe segment 76 with washer 82 inside of nut 88 between filter and pressure reducer unit 80 and threaded pipe segment 76. Washer 82 and O-ring 84 help form a water tight seal between filter and pressure reducer unit 80/nut 88 combination and cap 72/grommet 74/threaded pipe segment 76 combination. The connection of all of the components results in the invention 70.

Filter and pressure reducer unit 80 comprising a generally mesh-like or sieve-like cylindrical structure 106, a manifold 108, a flange 110, and a pressure reducer 112. Cylindrical structure 106 surrounds a generally hollow interior. Water entering the housing 98 flows through the perforations 134 in cylindrical structure 106 into the hollow interior and then out through the manifold 108 and the pressure reducer 112 into threaded pipe segment 76. The mesh-like or sieve-like configuration filters out debris from the water (prevents debris from entering the hollow interior) flowing from outside of the filter and pressure reducer unit 80 to inside of the filter and pressure reducer unit 80. It generally is preferable to have a filter as debris clogging the pressure reducer 112, the interior of the drip irrigation system components, the drip line, or the soaker hose can be difficult if not impossible to remove. Filter and pressure reducing unit 80 can be manufactured out of any suitable material, including plastics, metals, alloys, ceramics, composites, natural and artificial rubbers, and silicones.

Manifold 108 generally is a solid cylindrical feature extending upwards from cylindrical structure 106 and comprises a pressure reducer 112. Pressure reducer 112 can be a molded or formed feature on the interior of manifold 108 or can be a separate toroidal or ring-like structure inserted into the interior of manifold 108. Pressure reducer comprises a flow opening 114 allowing water to flow from the hollow interior of cylindrical structure 106. As the flow opening 114 is narrower (has a smaller diameter) than the interior of manifold 108, water flowing through the flow opening 114 loses pressure, and therefore lowers the pressure of the water flowing into the drip line system or the soaker hose system. If the drip line system or the soaker hose system is a high pressure system, or is capable of handling high pressure water, then a pressure reducer may not be necessary.

Flange 110 is a shoulder-like structure on the upper edge of, and extending outwardly normal to, manifold 108. A primary purpose of flange 110 is to seat the filter and pressure reducing unit 80 within nut 88 to help prevent water from circumventing the filter and pressure reducing unit 80 by traveling between the outside of manifold 108 and the inside of nut 88 and into threaded pipe segment 76.

Washer 82 is a common washer and is used to help seal filter and pressure reducer unit 80 against threaded pipe segment 76. As shown, washer has a trapezoidal cross-section to help create a better seal against flange 110, and particularly against the interior upper edge of manifold 108 proximal to flange 110. Any suitable washer can be used. O-ring 84 is a common flexible or compressible O-ring and is used to help seal nut 88 against grommet 74. Any suitable O-ring can be used.

Nut 88 is a common pipe fitting nut, hose thread adapter, or trap adapter and is used to secure filter and pressure reducer unit 80 to threaded pipe segment 76. As shown, nut 88 comprises an internal thread 118 and a lower shoulder 120. Nut 88 optionally can comprise a threaded extension 122 for use with optional accessories. Internal thread 118 cooperates with the external thread 124 of threaded pipe segment 76 such than nut 88 can be secured onto threaded pipe segment 76. Other manners of attachment are contemplated and suitable, such as adhesives and welding; however, screw threads are both simple and not permanent. Lower shoulder 120 extends inwardly from the bottom edge of nut 88 a distance sufficient to cooperate with flange 110 such that the cylindrical structure 106 and the manifold 108 of filter and pressure reducer unit 80 can extend entirely through the nut 88 with the flange 110 contacting the lower shoulder 120 so as to retain the flange 110 within, and therefore secure the filter and pressure reducer unit 80 to, the nut 88, when the filter and pressure reducer 80/washer 82/O-ring 84/nut 88 combination is secured to threaded pipe segment 76.

Referring now to FIG. 6, a side sectional view of the constructed invention with a generic housing 98 shown in ghost lines is shown. This view illustrates the constructed invention 70 as attached to an illustrative housing 98. A first portion of the threaded pipe segment 76 extends upwardly out of the housing 98, and the connector 78 is attached to this portion of the threaded pipe segment 76. A second portion of the threaded pipe segment 76 extends downwardly into the housing 98, and the filter and pressure reducer 80/washer 82/O-ring 84/nut 88 combination is secured to this portion of the threaded pipe segment 76. As can be seen, the filter and pressure reducer 80/washer 82/O-ring 84/nut 88 combination is sized to fit within the housing 98. Housing 98 comprises a water inlet or water inlet port 126 for connection to the water supply pipe or piping (not shown).

The cap 72 can be attached to the housing 98 in many different manners. As the prior art housings have screw threads, it can be preferable for cap 72 to have screw thread 96 on the interior surface of side wall 94 to cooperate with a screw thread on housing 98 so that cap 72 can be removably secured onto housing 98 in a generally watertight manner. As one alternative, cap 72 can be friction mounted onto housing 98. As another alternative, cap 72 can be welded, adhered by adhesive, or otherwise more or less permanently attached to housing 98. As already disclosed, it is preferable to use the cap 72 provided with the housing 98, particularly when using an already installed in-ground irrigation system (that is, a retrofit).

Referring now to FIG. 7, a perspective view of a connector 78 suitable for use with a drip line and comprising a nipple connector 130 is shown. Such a connector is known in the art and allows the invention 70 to be connected to an irrigation system having pipes without threaded connectors. This connector 78 can be threaded onto the upper portion of the threaded pipe segment 76 and the irrigation pipes can be friction held onto the nipple connector 130.

Referring now to FIG. 8, a perspective view of a connector 78 suitable for use with a soaker hose and comprising a screw thread connector 132 is shown. Such a connector is known in the art and allows the invention 70 to be connected to an irrigation system having pipes with threaded connectors. This connector 78 can be threaded onto the upper portion of the threaded pipe segment 76 and the irrigation pipes can be threaded onto the threaded screw connector 132.

The invention 70 can be a new manufacture installed with and as part of an in-ground irrigation system. The invention 70 also can be a retrofit installed in already-present housings 98 in place of rising sprinkler heads previously installed in an in-ground irrigation system. By adjustment of the various dimensions of the various components of the invention 70, the invention 70 can be modified or structured to cooperate with many of the known prior art water station housings already installed in in-ground irrigation systems.

While the invention has been described in connection with certain preferred embodiments, it is not intended to limit the spirit or scope of the invention to the particular forms set forth, but is intended to cover such alternatives, modifications, and equivalents as may be included within the true spirit and scope of the invention as defined by the appended claims.

What is claimed is:

1. A connection station for an irrigation system watering station, the watering station being of the in-ground type having a housing with an open top, a cap for cooperating with the open top, and a water inlet for allowing water under pressure to enter the housing, the connecting station comprising:
a pipe segment extending through the cap with a first portion of the pipe segment extending outwardly relative to the housing and a second portion of the pipe segment extending inwardly relative to the housing, the pipe segment allowing the water to exit the housing through the pipe segment;
a connector for connecting the first portion of the pipe segment to a water dispersal means, the connector directing the water to the water dispersal means and the water dispersal means for dispersing the water onto a landscape; and
a filter cooperating with the pipe segment for filtering debris out of the water prior to the water being directed to the water dispersal means.

2. The connection station as claimed in claim 1, wherein the pipe segment and the connector comprise cooperative screw threads for removable threaded coupling to each other.

3. The connection station as claimed in claim 1, wherein the pipe segment comprises a screw thread whereby the filter can be removably threadably coupled to the pipe segment.

4. The connection station as claimed in claim 1, wherein the pipe segment and the connector comprise cooperative screw threads for removable threaded coupling to each other and the filter can be removably threadably coupled to the pipe segment.

5. The connection station as claimed in claim 1, wherein the cap and the pipe segment are a single molded unit.

6. The connection station as claimed in claim 1, further comprising a pressure reducer unit for reducing the pressure of the water exiting the housing relative to the pressure of the water entering the housing.

7. The connection station as claimed in claim 6, wherein the pressure reducer unit is located between the filter and the pipe segment.

8. The connection station as claimed in claim 6, wherein the pressure reducer unit is a part of the filter.

9. The connection station as claimed in claim 1, wherein the connector comprises a nipple for friction coupling to the water dispersal means.

10. The connection station as claimed in claim 1, wherein the connector comprises a screw thread for threaded coupling to the water dispersal means.

11. The connection station as claimed in claim 1, wherein the cap, the pipe segment, and the connector are a single molded unit.

12. A connection station for an irrigation system watering station, the watering station being of the in-ground type having a housing with an open top, a cap for cooperating with the open top, and a water inlet for allowing water under pressure to enter the housing, the connecting station comprising:
a pipe segment extending through the cap with a first portion of the pipe segment extending outwardly relative to the housing and a second portion of the pipe segment extending inwardly relative to the housing, the pipe segment allowing the water to exit the housing through the pipe segment;
a connector for connecting the first portion of the pipe segment to a water dispersal means, the connector directing the water to the water dispersal means and the water dispersal means for dispersing the water onto a landscape;
a filter cooperating with the pipe segment for filtering debris out of the water prior to the water being directed to the water dispersal means; and
a pressure reducer unit for reducing the pressure of the water exiting the housing relative to the pressure of the water entering the housing.

13. The connection station as claimed in claim 12, wherein the pipe segment and the connector comprise cooperative screw threads for removable threaded coupling to each other.

14. The connection station as claimed in claim 12, wherein the pipe segment comprises a screw thread whereby the filter can be removably threadably coupled to the pipe segment.

15. The connection station as claimed in claim 12, wherein the pipe segment and the connector comprise cooperative screw threads for removable threaded coupling to each other and the filter can be removably threadably coupled to the pipe segment.

16. The connecting station as claimed in claim 15, wherein the filter is part of a unit comprising a manifold and the pressure reducer unit is located within the manifold, whereby the water passes through the filter into the manifold, then through the pressure reducer unit into the pipe segment.

17. The connection station as claimed in claim 12, wherein the cap, the pipe segment, and the connector are a single molded unit.

18. An in-ground connection station for an irrigation system, the connecting station comprising:
a housing having an open top and a water inlet for allowing water under pressure to enter the housing;
a cap for cooperating with the open top;
a pipe segment extending through the cap with a first portion of the pipe segment extending outwardly relative to the housing and a second portion of the pipe segment extending inwardly relative to the housing, the pipe segment allowing the water to exit the housing through the pipe segment;
a connector for connecting the first portion of the pipe segment to a water dispersal means, the connector directing the water to the water dispersal means and the water dispersal means for dispersing the water onto a landscape;
a filter cooperating with the pipe segment for filtering debris out of the water prior to the water being directed to the water dispersal means; and
a pressure reducer unit for reducing the pressure of the water exiting the housing relative to the pressure of the water entering the housing

19. The connection station as claimed in claim 18, wherein the pipe segment and the connector comprise cooperative screw threads for removable threaded coupling to each other and the filter can be removably threadably coupled to the pipe segment.

20. The connecting station as claimed in claim 19, wherein the filter is part of a unit comprising a manifold and the pressure reducer unit is located within the manifold, whereby the water passes through the filter into the manifold, then through the pressure reducer unit into the pipe segment.
